(19) United States
(12) Patent Application Publication
(10) Pub. No.: US 2008/0005431 A1
(43) Pub. Date: Jan. 3, 2008

(54) Data Transfer Method in a Distributed Process Control System

(76) Inventor: Pasi Juppo, Vassa (FI)

Correspondence Address: SMITH-HILL AND BEDELL, P.C., 16100 NW CORNELL ROAD, SUITE 220, BEAVERTON, OR, 97006, US

(21) Appl. No.: 11/569,940

(22) PCT Filed: May 13, 2005
(86) PCT No.: PCT/FI05/50159

§ 371 Date: Feb. 14, 2007

(30) Foreign Application Priority Data
Jun. 1, 2004 (FI) 20045202

(51) Int. Cl. G06F 13/42

(52) U.S. Cl. 710/106

(57) ABSTRACT

A method in the data transfer of a distributed process control system in which a number of modules of the process control system are arranged in data transfer connection with each other using CAN protocol over a bus, in which method the modules transmit and receive messages containing at least an identifier part and an information part. The content of the identifier part of each transmitted message is dynamically formed at least partly in the transmitting module.

The present invention relates to a method in the data transfer of a distributed process control system as described in the preamble of claim 1, in which a number of the modules of the control system are arranged in data transfer connection with each other over bus using CAN (Controller Area Network) protocol.

The invention also relates to a computer program as described in the preamble of claim 7 and a computer program in the data transfer of a distributed process control system as described in the preamble of claim 11.

CAN (Controller Area Network) bus is widely used in the data transfer of a number of process control systems for different processes and devices, such as cars, work machines and robots. CAN bus is inherently a multi-master bus and its basic specification is specified in e.g. standard ISO 11989. Each node, i.e. module, of a CAN bus can independently send a message to the bus. The message can be read by all modules and only modules that are, e.g. programmed to operate in that way, receive the message.

CAN specification as such, however, needs a lot of programming work in applications and it is also relatively inflexible in functionality. In it, e.g. the identifier part of each message is completely defined in advance already during the programming phase and/or configuration phase of the system. It is, however, very common that the process conditions vary and in this case the importance of various functions in the process control also varies. Taking this into account in the known CAN specification is possible only when predetermined, i.e. all necessary identifier parts must configured in advance, making the system inflexible.

CAN bus is also used in the control of internal combustion engines. As the importance of the engine control has been increased because of, among others, more stringent emissions goals, the known CAN specification does not operate so as to allow a sufficiently flexible and powerful engine control. In engines, a number of measurement and control devices are needed in a relatively small space. Thus, the data transfer capacity must be sufficient.

An object of the invention is to accomplish a method in the data transfer of a distributed process control system, in which a number of modules belonging to the control system are arranged in data transfer connection with each other using CAN (Controller Area Network) protocol via bus and in which method the modules send and receive messages containing at least the identifier part and the information part of the message signal, the method improving the operation of the known process control system.

An especial aim of the invention is to produce a control system for an internal combustion engine, by means of which the engine control can be made fast and thereby a stable, safe and efficient operation of the engine can be achieved.

The aims of the invention are mainly achieved as disclosed in the appended claims 1, 7 and 11 and disclosed in more detail in other claims.

In a method in data transfer of a distributed process control system according to the invention, in which system a number of the modules of process control system are arranged in data transfer connection with each other using the CAN (Controller Area Network) protocol via bus, in which method the modules send and receive messages containing at least the identifier part and the information part of the message, with the identifier part of the message being formed dynamically at least partly in the sending module. This allows the requirements of the process to be taken better into consideration as necessary in each case and also in a rather simple manner.

Especially in a case in which a message describing the status of the process to be controlled is to be sent, the part of the identifier part defining the priority of the message is formed individually for each message as a response to the status information of the process being in connection with the module.

Preferably at least the address data of the module receiving the message is included in the identifier part, whereby the speed of message processing is increased. Preferably the address data of the sending module is as well included in the identifier part, whereby the origin of each message can be read from the message. According to the invention, the part defining the address data of the module receiving the message is individually formed for each message. It is additionally preferable to internally divide the address data of the identifier part into two parts, the most significant part of which specifies the group of the target of the message and the least significant part of which specifies the target of the message within the group. This allows the message to be targeted to a certain group or groups, thereby also reducing the unnecessary load of the bus and, most importantly, reducing processing load in devices for which the message is not meant.

According to the invention, a part defining the priority is first formed into the identifier part, subsequent to which the address date of the receiving module, the address data of the sending module and the data part are formed. Thus it is possible to address the data to only one module or modules, thereby avoiding unnecessary processor loading of the modules, which increases the operation speed of the system.

The method is especially suitable for use in the control of the operation of an internal combustion engine. The method comprises steps in which the data part of the message to be formed is compared to the set value or preset value window of a information part stored in the module and in case the information part deviates from the set value or set value window by more than is predetermined, the priority value of the message to be formed is increased, whereby a fast delivery of the data can be ensured. In this case the information part comprises data about the measurement value of the operation of the internal combustion engine. Additional advantages are achieved by dividing the engine into operational groups and correspondingly in the operation of the control system, information about each operational group meant as the receiver of each message is included into the address data of the information part of the messages when forming the message.

A computer program according to another embodiment of the invention in the data transfer of a distributed process control system, in which a number of the modules of the control system are arranged in data transfer connection applying the CAN (Controller Area Network) protocol with each other over the bus, includes a section for forming messages for the CAN bus, the messages containing at least the identifier part and the information part of the message. According to the invention the said section of the computer program forms a value of the identifier part of the message on the basis of the value or values set into the information part of the message for having an effect on the processing of the message. Preferably the said section of the computer program forms the value of the priority of the identifier part of the message.

Several advantages are achieved by means of the invention. Most importance can be placed on the fact that by dynamically setting the identifier part the transmission of messages can be effectively influenced on the bus, which is important in connection with especially malfunction situations. Further, the invention allows increasing the safety and stability of the process control system and the apparatus controlled therewith. In addition to this, the data transfer capacity of the bus is increased and unnecessary process loading is avoided.

In the following the invention is described by way of example and with reference to the appended drawings, of which

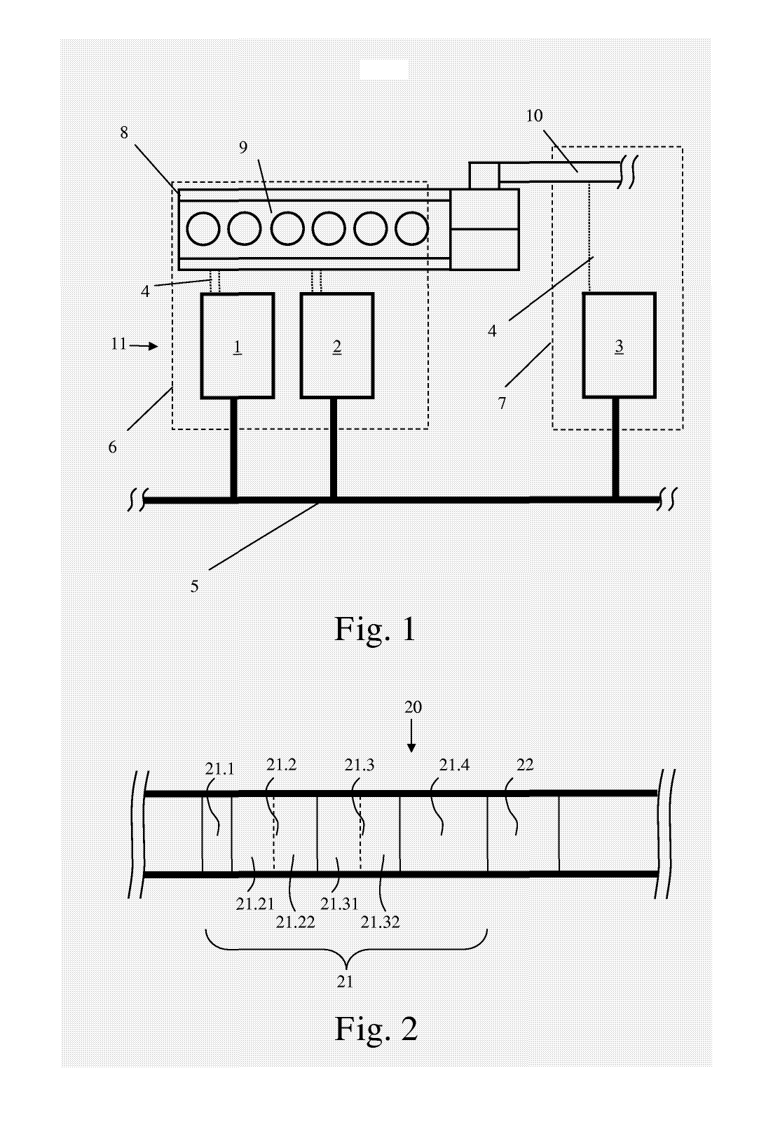

FIG. 1 illustrates an application according to the invention in connection with an internal combustion engine,

FIG. 2 illustrates a message produced by the method according to the invention,

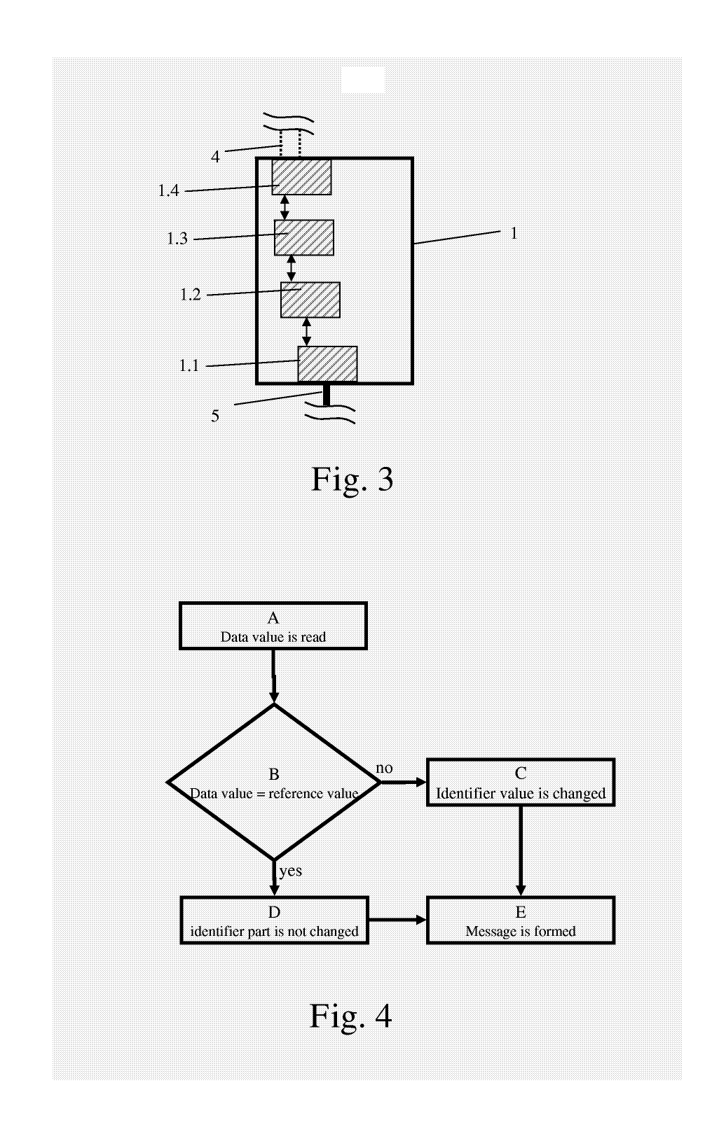

FIG. 3 illustrates a module of FIG. 1 that can be connected to a CAN bus, and

FIG. 4 illustrates a diagram of a method according to the invention.

FIGS. 1 schematically illustrates a piston engine 8. The construction of the engine is divided into functional groups, such as the cylinders 9 and exhaust gas system 10 illustrated here. A process control system 11 is arranged in connection with the engine, the system being also divided into groups to accomplish the control of certain functional groups of the engine. Here, modules 1 and 2 are schematically shown to belong to the cylinder group 6. An exhaust gas group 7 of the process control system 11 is arranged to control the exhaust gas system, the exhaust gas group here consisting of one module 3. The modules can act as transmitters of, among others, measurement and control data and also accomplish the control of the actual process. The modules are arranged in data transfer control with each other using CAN (Controller Area Network) protocol via bus 5. The bus can be, for example, of pair cable type, optical or other suitable solution. The modules are in connection to the actuators and/or measurement devices located in the engine 8 via conductors 4.

As the engine runs, each module 1, 2, 3 of the process control system executes the functions set and/or programmed for it in a way defined by the program stored in each module 1, 2, 3. The program stored in the modules and run therein forms the message itself and sends it to the bus. The program is such that it can form messages with different contents. According to the invention, the content of the so-called identifier part of the message is dynamically formed at least partly in the sending module as a response to the actual information of the process in connection with the module.

The structure of the message 20 formed by the module is exemplarily shown in FIG. 2. The message 20 always comprises an identifier part 21 and an information part 22. The data itself occurring on the bus comprises other parts as well, e.g. data relating to the CAN protocol. The identifier part 21 of the actual message 20 first comprises the part 21.1 determining the priority of the message.

The processing of the message is determined on the basis of this in a situation where one or more modules is/are attempting to transfer data at the same time. In this case, the message to be transferred first is solved by comparing identifier parts so that the message having the smallest priority number goes first. The identifier part also includes the address 21.2. of the receiving module and the address 21.3 of the transmitting module. Finally, the identifier part comprises data part 21.4, subsequent to which is the information part 22 of the actual message. According to the CAN protocol the size of the identifier part of the message is preferably 29 bits. For example, three bits can be reserved for the priority 21.1 of the identifier part 21 and eight bits for each of the module addresses; thus data 21.4 can as well be included in the identifier part 21 of the message, in this case ten bits. Thus the data transfer capacity of the bus is considerably increased, whereby the performance of the modules is improved and thus also the operation of the engine is improved.

According to one embodiment of the invention the processing of the messages in the bus can be made essentially faster by including the address 21.2 of the receiving module in the identifier field of the message. This will considerably improve process control in applications requiring fast data transfer, such as a piston engine. The address data is formed as a two-part data, consisting of the most significant part 21.21 and the least significant part 21.22. The most significant part 21.21 of the address determines the group for which the message is meant to. In the case illustrated in FIG. 1 the module 3 can thereby send a message into which it generates the most significant part 21.21 of the address 21.2 of the receiving module such that it means the cylinder group 6. Thus, the message is in the first step only directed at this group, because other modules of the bus can detect right at the beginning of the transfer of the message that it is not addressed to them. The least significant part 21.22 determines the address to closer apply to either all modules 1 and 2 of the cylinder group 6 or only some of them. Thus, the same message can be directed to be read by a number of modules. Further, this simplifies and accelerates the processing of the message.

With reference to the illustration in FIG. 1, the engine process control system can be considerably improved by means of a preferable embodiment of the invention disclosed in the following as an application of exhaust gas temperature monitoring.

It is obvious that the method can be applied to a number of other processes a well using a corresponding principle. In normal circumstances the module 3 of the exhaust gas group 7 sends to the bus for example with regular intervals the exhaust gas measurement value transmitted to the module 3. In normal conditions the program forms the identifier part 21 of the message 20 having a certain first priority value 21.1. According to the invention the value of the priority is individually formed for each message to be sent, in this case depending on the measurement value of the exhaust gas temperature available at module 3. In order to accomplish this a computer program has been stored in module 3 for controlling the operation of the module. The program forms the message to be sent to the bus in each case. The program includes a section for forming the identifier part dynamically, i.e. case by case, preferably depending on the value of the information part 22 of the message. The contents of the identifier part 21, in this example, depends on the exhaust gas temperature measurement value received by module 3. In a situation in which the exhaust gas temperature changes so as to be outside a certain predetermined limit value window, a computer program or its section being run in module 3 determines a second priority value for the priority value of the message, smaller than the previous values. Due to this, in the new situation the messages sent by module 3 receive a bus priority with a lower value, i.e. a higher priority in the sending hierarchy and they are sure to be sent in time. Thus the operation and data transfer of the CAN bus can be more efficiently adapted to correspond with the situation.

FIG. 3 shows in more detail the module 1, connectable to CAN bus 5, shown in FIG. 1. In addition to the CAN bus, the module is connected to the process device in the module control via suitable conductors 4. For this, the module comprises a process interface unit 1.4, by means of which the module communicates with the process device. The module comprises at least a transmitter/receiver unit 1.1 of the message by means of which the module 3 communicates with the CAN bus. A module according to the invention additionally comprises an information value comparison unit 1.3, into which information about the measurement value or values is transferred by means of a process interface unit 1.4. The data value comparison unit 1.3 compares the measurement values of the process to the set value or set value window available to the comparison unit 1.3 and transfers reference data into the forming part of the identifier unit 1.2 included in the module, the forming part then forming the identifier part of the message on the basis of the reference data. The identifier part thus formed is connected to other parts of the message and delivered to the message transmitter/receiver unit 1.1. In the module, at least the forming part 1.2 of the identifier unit and the data value comparison unit 1.3 are preferably realized by means of a computer program.

FIG. 4 shows a simplified version of the phases of the method according to the invention for producing a message containing a dynamic identifier part for CAN bus in a module connectable to the bus. In the first phase A a data value describing the status of the process is read from the process. Alternatively, the data value can in some cases be from a message originating from another module. In the next phase B the data value is compared with the predetermined comparison value. In case the data value differs from the comparison value the identifier part is changed, preferably priority-defining part thereof. If the there is no difference, the identifier part will not be changed. The message is formed subsequent to this. In the above, a certain range can be used instead of the comparison value, whereby the system checks whether the data value is inside or outside this value.

The invention is not limited to the embodiments described here, but a number of modifications thereof can be conceived of within the scope of the appended claims.

1-9. (canceled)

10. A method of operating a distributed process control system that comprises a plurality of modules communicating with each other by transmitting and receiving messages over a bus, wherein each message includes an identifier part and an information part and the identifier part of a message specifies a message priority, said method comprising dynamically forming at least part of the identifier part of a message in the transmitting module, and wherein the step of dynamically forming the identifier part of the message includes:
comparing the information part of the message to a set value or a set value window and, in the event that the information part differs from the set value or the set value window by more than a predetermined amount,
changing the priority of the message.

11. A method according to claim 10, wherein a transmitting module includes the address data of a receiving module in the identifier part of the message.

12. A method according to claim 11, wherein the step of dynamically forming the identifier part of the message includes:
including the address data of the receiving module in the identifier part of the message.

13. A method according to claim 11, wherein the receiving module is one module of a group that contains at least two modules, the address data of the receiving module comprises a more significant part that defines the group and a less significant part that specifies the receiving module within the group, and the more significant part and the less significant part of the address data are included separately in the identifier part of the message.

14. A method according to claim 11, wherein the transmitting module includes its own address data in the identifier part of the message.

15. A method according to claim 14, wherein the transmitting module is one module of a group that contains at least two modules, the address data of the transmitting module comprises a more significant part that defines the group and a less significant part that specifies the transmitting module within the group, and the more significant part and the less significant part of the address data of the transmitting module are included separately in the identifier part of the message.

16. A method according to claim 10, wherein the identifier part of the message includes a priority part, followed by address data of the receiving module, followed by address data of the transmitting module.

17. A method according to claim 10, wherein the step of dynamically forming the identifier part of the message includes:
comparing the information part of the message to the set value or the set value window, and
increasing the priority of the message in the event that the message priority is lower than highest priority and the information part exceeds the set value or the set value window by more than a predetermined amount.

18. A method of operating a distributed process control system of an internal combustion engine, wherein the control system comprises a plurality of modules controlling and/or monitoring operation of the engine and communicating with each other by transmitting and receiving messages over a bus, wherein each message includes an identifier part and an information part and the identifier part of a message specifies a message priority, said method comprising dynamically forming at least part of the identifier part of a message in the transmitting module, and wherein the step of dynamically forming the identifier part of the message includes:
comparing the information part of the message to a set value or a set value window and, in the event that the information part differs from the set value or the set value window by more than a predetermined amount,
changing the priority of the message.

19. A method according to claim 18, wherein the internal combustion engine is composed of functional groups, each of which comprises at least one module, and a message transmitted by a transmitting module to a receiving module includes a reference to the group that contains the receiving module and to the receiving module.

20. A method according to claim 19, wherein the identifier part of the message includes a two-part data composed of a more significant part that identifies the group that contains the receiving module and a less significant part that identifies the receiving module within the group.

21. A method according to claim 18, wherein the step of dynamically forming the identifier part of the message includes:
comparing the information part of the message to the set value or the set value window, and
increasing the priority of the message in the event that the message priority is lower than highest priority and the information part exceeds the set value or the set value window by more than a predetermined amount.

22. A computer program for control of data transfer in a distributed process control system that comprises a plurality of modules communicating with each other by transmitting and receiving messages over a bus, wherein each message includes an identifier part and an information part, the identifier part of a message specifies a priority value for influencing processing of the message, and the program includes a section for forming a message to be transmitted over the bus, wherein said section of the computer program forms the priority value based on at least one value in the information part of the message.

23. A program according to claim 22, when contained in a storage medium.
